(19) United States
(12) Patent Application Publication
(10) Pub. No.: US 2025/0013947 A1
(43) Pub. Date: Jan. 9, 2025

(54) Rendering a Private and Dynamic Presenter View Screen to Coordinate With Software Simulations for the Purpose of Enabling Realistic Sales Demonstrations

(71) Applicant: 3SHARP LLC, Redmond, WA (US)

(72) Inventors: Peter Kelly, Queen Creek, AZ (US); Jeremy Campbell, Bellevue, WA (US)

(73) Assignee: 3SHARP LLC, Redmond, WA (US)

(21) Appl. No.: 18/766,325

(22) Filed: Jul. 8, 2024

Related U.S. Application Data
(60) Provisional application No. 63/512,485, filed on Jul. 7, 2023.

(51) Int. Cl. G06Q 10/0631

(52) U.S. Cl. CPC G06Q 10/0631

(57) ABSTRACT

Systems and methods for rendering a private and dynamic presenter view screen to coordinate with software simulations for the purpose of enabling realistic sales demonstrations are disclosed. Embodiments enable sales professionals to start a demo with little or no preparation and still confidently walk a prospective customer through the product and its features, and selling points, without the sales professional guidance being visible to the customer.

### PRIORITY CLAIM

This application claims priority to U.S. Prov. Pat. Appl. No. 63/512,485 filed Jul. 7, 2023, the contents of which are hereby incorporated by reference as if fully set forth herein.

### COPYRIGHT NOTICE

This disclosure is protected under United States and/or International Copyright Laws. © 2024. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND OF THE INVENTION

In the software-product industry, for salespeople who use software simulations to demonstrate product capabilities for sales purposes, there is a need to show a realistic view of the product to the customer, while providing real-time guidance to the salesperson indicating what clicks and interactions to execute as well as what to say during the presentation.

There are several approaches currently in use. One is to use a demonstration script document with verbiage to indicate where to interact with the simulated product demonstration and what to say. Another approach is to provide a video to train the seller how to show the demonstration. A third approach is to provide a “training mode” within the simulation, where words and instructions are provided over the top of or alongside the product demonstration visuals, and then are turned off for the presentation to the customer. There are problems associated with each of the three current methods.

The first method requires the salesperson to manually scroll through the document as they advance through the demonstration and to track which part of the document to read. For longer demonstrations especially, this can be a challenge, and salespeople can easily lose track of where in the document they can find the appropriate instructions for the particular screen of the demonstration they are active on.

The second method requires the salesperson to remember actions and words.

The third method also requires the salesperson to remember actions and words. Salespeople will sometimes turn the onscreen guidance back on for their presentation to the customer, and this hinders the experience because the customer then sees this information as well, whereas preferably they should only see the product.

Accordingly, there is a need for a solution that solves the foregoing problems.

### BRIEF DESCRIPTION OF THE DRAWING FIGURES

FIG. 1 is a screenshot of the main user interface of an embodiment of the invention.

FIG. 2 is a screenshot of a product demo launched from an embodiment of the invention.

FIG. 3 is an enlarged and zoomed-in version of the screenshot of a product demo launched from the embodiment illustrated in FIG. 2.

FIG. 4 is a flow diagram of the display logic of an embodiment of the invention.

FIGS. 5-7 are screenshots illustrating an alternative embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

One or more embodiments provide sales professionals real-time information about the software product demo they are presenting. A key insight into the software industry and the software sales process that is embodied in the invention is that, for certain key and broad use cases, the sales professional does not always have time to learn or prepare a demo ahead of a sales call, but it can be vital to the sales process to show potential customers the product as soon as possible. The invention makes it possible for the sales professional to start a demo with little or no preparation and still confidently instruct a user about the product and its features, and selling points, without the guidance being visible to the customer.

When the product demo has been created ahead of time with the sales professional in mind, it will contain metadata defining each step in the demo, where the user should click next to advance the demo, and notes for the user on what they should say to the customer at this point in the demo. With this metadata defined the invention loads the demo in the web browser and displays a preview of the starting page and any associated notes. From there, the user can use a button in the invention to launch the demo into another web browser window. The preview in the invention shows the user where to click in the launched demo. As the user clicks in the demo, the demo window communicates back to the invention the current step the user is on so that the user interface (UX) can be updated with the appropriate preview and notes.

The present invention provides a method and system for displaying step-by-step information to a user performing a software product demo. In this invention, the concept of a software product demo is defined as a step-by-step demonstration that will be shown either in person or virtually by a user, to one or more people for the purposes of educating them about the software product as part of the sales or training processes. The invention reads metadata about the demo in a known format, that preferably contains information for each step in the demo, including: information about what will be shown on the screen either as images, video, HTML, or other content that can be rendered by a web browser; notes detailing information the presenter needs to know about the current step, such as the features or benefits of the software being shown; information about which areas of the display are clickable by the user, and which one should be clicked to continue the demo on the default path.

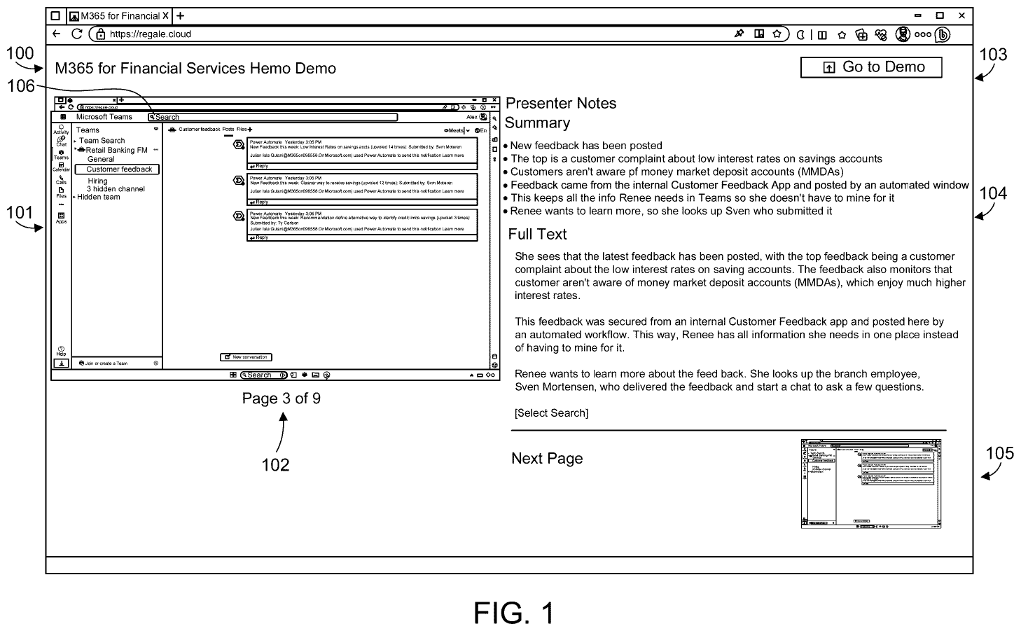

FIG. 1 is a screenshot of the presenter's view of an embodiment of the invention. When the user loads the GUI view shown in FIG. 1 using a processing device and display, the processing device receives metadata about the demo being presented and displays the demo title in section 100. Then it loads or renders the display of the first step of the demo in section 101. This display of section 101 shows the view that is or will be displayed in the demo when running, along with an overlay showing the next step to click on. In the illustrated example this is a pulsing orange rectangle (click beacon) at the bottom or top of the image of section 101. Section 102 shows the current step in the demo, and the total number of demo steps. On the top right of the display, section 103, is the button to launch the actual demo. If the demo has already been launched, then clicking the button again will bring the demo back to the active state in the foreground. Below that in section 104, are the presenter notes that were loaded from the metadata for the current demo step. In section 105 is a preview of what the next page will look like, assuming the user follows the default flow of the demo.

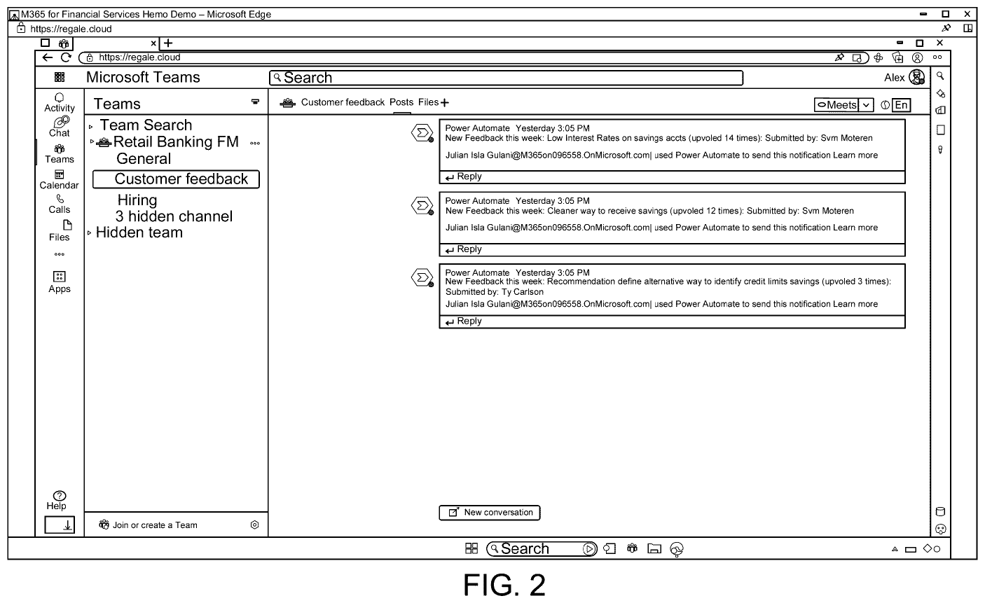

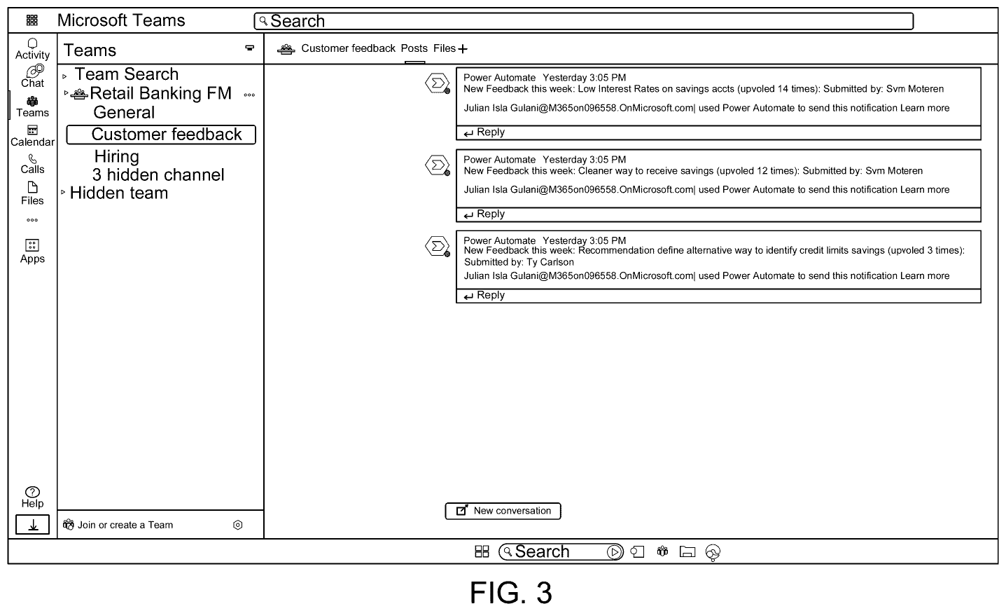

FIGS. 2-3 are a screenshot of a demo launched according to the present invention. The launched demo does not show any of the overlay layers by default, so that the demo appears as similar to the product as possible. As the user clicks in the appropriate spots in the demo, a message is sent to the invention letting it know that a new step is being displayed so that the presenter's view can be updated with new previews and notes.

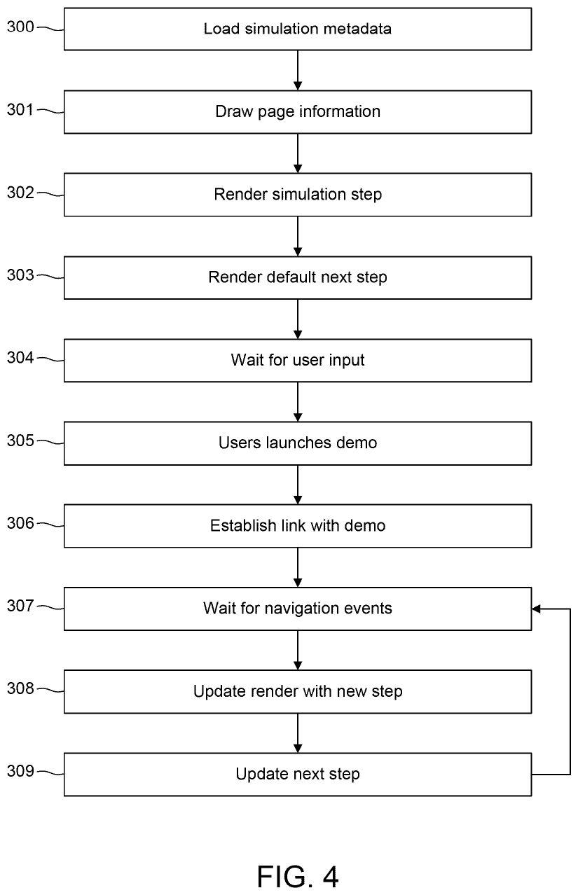

FIG. 4 is a flow diagram of the program logic of the invention. The invention first loads the metadata about the demo being shown at a step 300. This metadata will contain all the information about the demo, such as the title, sections, individual demo steps, clickable areas, and any other overlays that may be shown to the user. Then, in step 301, the invention begins rendering the demo user interface, starting with the title of the demo, the presenter notes, and the current location in the demo. In step 302, the preview of the current step is rendered, or loaded from an external source as necessary or desired. This includes rendering the click beacon for the default step the user should take next in the demo. Next the invention renders the preview of the next default step in step 303. Once the initial user interface has been rendered, the invention waits for user input in step 304. The next response from the user should be to launch the demo in step 305. Once the demo is launched, the invention opens a communication channel with the demo and confirms that they can communicate, in step 306. The invention waits, in step 307, for user input in the demo to fire a navigation event of the communicate channel. Once one is received, in step 308, the user interface is updated to show the relevant information for the new demo step. This includes updating the current step number, presenter notes, preview window. Then in step 309, the next default demo step preview is updated, and the invention goes back to waiting for a new navigation event in step 307.

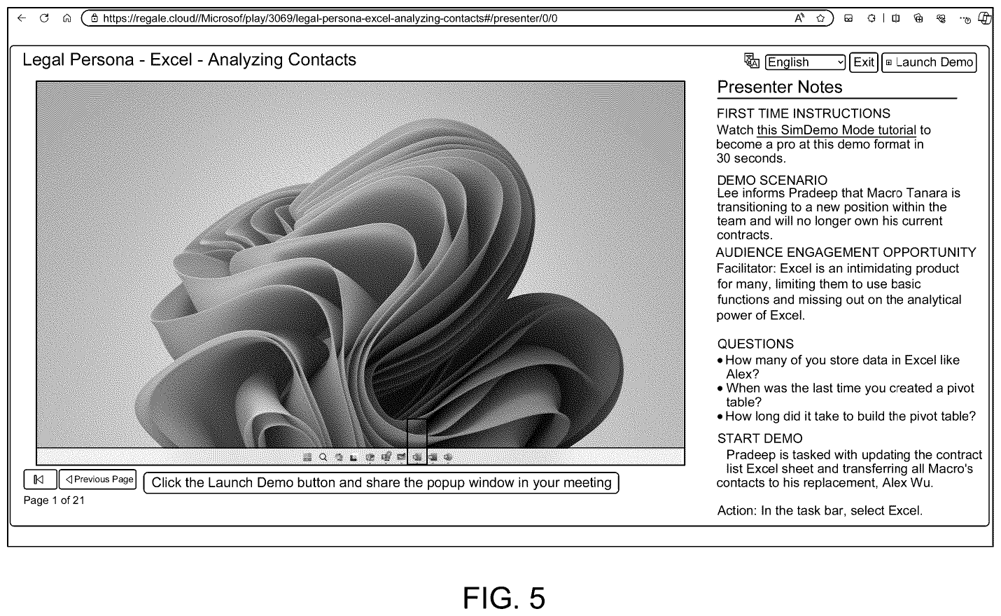

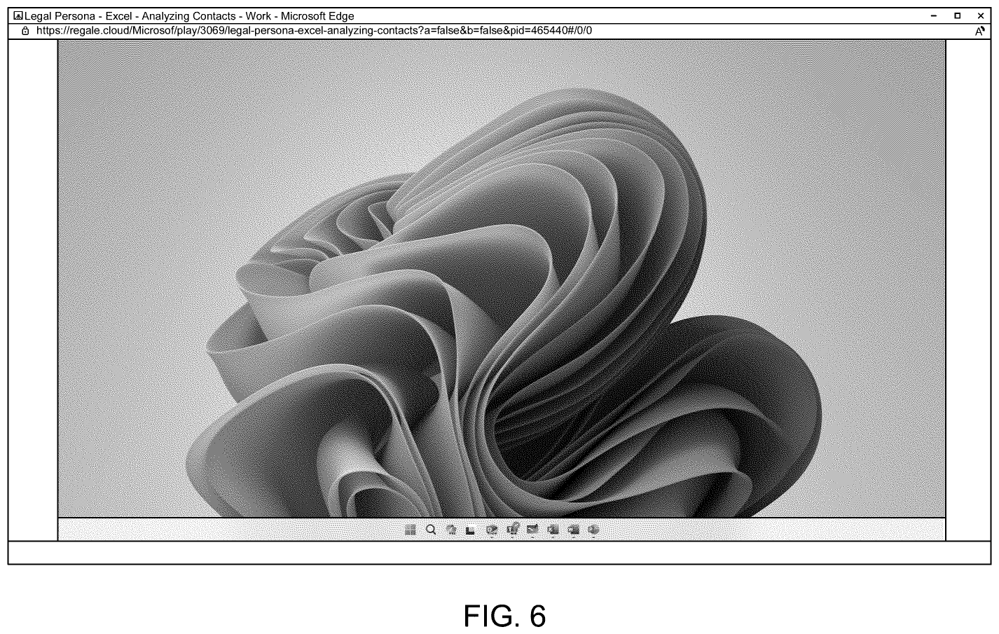

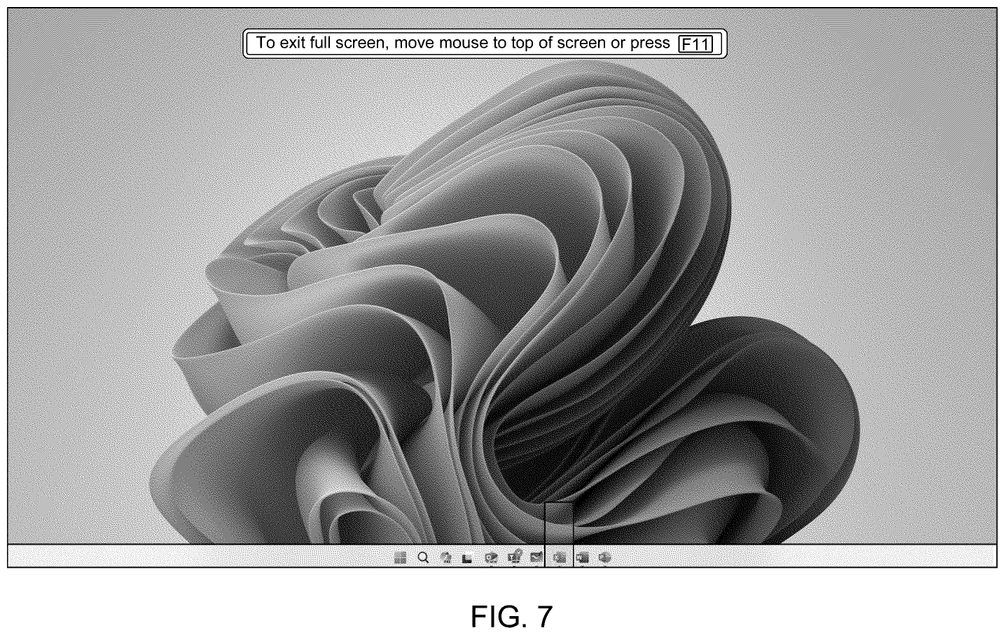

FIGS. 5-7 illustrate an alternative embodiment of the invention. As such, one or more embodiments provide a system providing a sales demonstration presentation rendered on a computer screen and viewable by a customer audience, as well as a presenter view rendered on a computer screen with presenter notes separate from the sales demonstration presentation that is viewable by the presenter but not viewable by the customer audience, and includes a preview of an upcoming slide in the sales demonstration.

Although the foregoing text sets forth a detailed description of numerous different embodiments, it should be understood that the scope of protection is defined by the words of the claims to follow. The detailed description is to be construed as exemplary only and/or does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and/or variations may be made in the techniques and/or structures described and/or illustrated herein without departing from the spirit and/or scope of the present claims. Accordingly, it should be understood that the methods and/or apparatus described herein are illustrative only and/or are not limiting upon the scope of the claims.

What is claimed is:

1. At least one computer-readable medium on which are stored instructions that, when executed by one or more processing devices, enable the one or more processing devices to perform a method, the method comprising the steps of:
(a) loading metadata about a computer-based demonstration (“demo”);
(b) rendering a user interface associated with the demo;
(c) rendering a preview of the current step in the demo;
(d) rendering a preview of a successive default step;
(e) receiving from a user an instruction to launch the demo;
(f) upon demo launch, opening a communication channel with the demo;
(g) receiving from the user an instruction in the demo to fire a navigation event of the communication channel;
(h) upon receipt of the instruction, updating the user interface to show relevant information associated with the new demo step;
(i) updating a next default demo step preview; and
(j) repeating steps (g)-(i).

2. The medium of claim 1, wherein the metadata contains at least one of the demo title, demo sections, individual demo steps, clickable areas of the demo interface, and other overlays that may be shown to a demo user.

3. The medium of claim 1, wherein the user interface includes at least one of a title of the demo, presenter notes, and a current location in the demo.

4. The medium of claim 1, wherein the preview of the current step is loaded from an external source.

5. The medium of claim 1, wherein the method further includes rendering a click beacon for a default step a user should take next in the demo.

6. The medium of claim 1, wherein the method further includes updating at least one of a current step number, presenter notes and preview window.
